(19) United States
(12) Patent Application Publication
(10) Pub. No.: US 2014/0354218 A1
(43) Pub. Date: Dec. 4, 2014

(54) MAGNETIC MOUNTING SOLUTION FOR ELECTRONIC DEVICES WITH INTEGRATED CONDUCTIVE CHARGING OF THE DEVICE

(71) Applicants: ALI KAYNAR, Istanbul (TR); PAULUS MARIA WARMER, Muang Udon Thani (TH)

(72) Inventors: ALI KAYNAR, Istanbul (TR); PAULUS MARIA WARMER, Muang Udon Thani (TH)

(21) Appl. No.: 14/451,366

(22) Filed: Aug. 4, 2014

Related U.S. Application Data
(60) Provisional application No. 61/830,816, filed on Jun. 4, 2013.

(30) Foreign Application Priority Data
Aug. 10, 2013 (CN) ZL2013120490193.4

(51) Int. Cl. H02J 7/00; H01F 7/02

(52) U.S. Cl. CPC H02J 7/0044; H01F 7/0252; H02J 7/0052
USPC 320/107

(57) ABSTRACT

A magnetic mounting system is configured to charge a personal electronic device with integrated conductive charging of the personal electronic device. The system includes a case, configured to connect to the personal electronic device. The case is attached to a printed circuit board, wiring and a plurality of metal plates. A housing is arranged proximate the casing. The housing further comprises a plurality of magnets and a plurality of pins. Aligning the plurality of magnets with the plurality of pins detachably couples the case to the housing. Aligning the plurality of pins and the printed circuit board provides electricity from the plurality of pins to the printed circuit board when the case is attached to the housing to charge the personal electronic device in the case.

### RELATED APPLICATION

This application claims priority to provisional patent application U.S. Ser. No. 61/830,816 filed on Jun. 4, 2013 and Chinese Utility Model Application No.: ZL 2013120490193.4 filed on Aug. 10, 2013, the entire contents of which is herein incorporated by reference.

### BACKGROUND

The embodiments herein relate generally to personal electronics. In particular, the embodiments herein relate generally to mounting personal electronic devices and charging a personal electronic device after it are mounted.

When using an electronic device, such as, e.g., a smartphone, in a car, the device should be properly mounted and charged. Current mounting solutions often require two hands to mount the device correctly. Once the device is mounted, a power cable needs to be connected separately. This process is relatively complex and time consuming. Embodiments of the disclosed invention solve these problems.

### SUMMARY

A magnetic mounting system is configured to charge a personal electronic device with integrated conductive charging of the personal electronic device. The system includes a case, configured to connect to the personal electronic device. The case is attached to a printed circuit board, wiring and a plurality of metal plates. A housing is arranged proximate the casing. The housing further comprises a plurality of magnets and a plurality of pins. Aligning the plurality of magnets with the plurality of pins detachably couples the case to the housing. Aligning the plurality of pins and the printed circuit board provides electricity from the plurality of pins to the printed circuit board when the case is attached to the housing to charge the personal electronic device in the case.

In some embodiments, a base is mechanically coupled to the housing. A suction cup is mechanically coupled to the base. The suction cup is configured to detachably couple the base to a glass surface.

In some embodiments, a front plate is mechanically coupled to the housing. The front plate is directly attached to the plurality of magnets and the plurality of pins and a recessed area. The recessed area is surrounded by an embossed ring.

In some embodiments, a protrusion around the printed circuit board. Aligning the protrusion with the embossed ring aligns the case to the front plate.

In some embodiments, a connector is attached to the printed circuit board with wiring. The connector is electrically coupled to the personal electronic device to charge the personal electronic device.

### BRIEF DESCRIPTION OF THE FIGURES

The detailed description of some embodiments of the invention is made below with reference to the accompanying figures, wherein like numerals represent corresponding parts of the figures.

FIG. 1 shows a schematic perspective view of an exemplary embodiment of a mounting system, according to the present disclosure;

FIG. 2 shows an exploded perspective view of the exemplary embodiment of FIG. 1;

FIG. 3 shows a reverse exploded view of the front plate of the exemplary embodiment of FIG. 1;

FIG. 4 shows a cross-section view of the front plate of the exemplary embodiment of FIG. 1, taken along line 4-4 in FIG. 2;

FIG. 5 shows a perspective view of an alternate exemplary embodiment of a mounting system, according to the present disclosure; and

FIG. 6 shows a rear plan view of the front plate of the exemplary embodiment of FIG. 1, with several details removed to demonstrate orientation of the plurality of magnets.

### DETAILED DESCRIPTION OF CERTAIN EMBODIMENTS

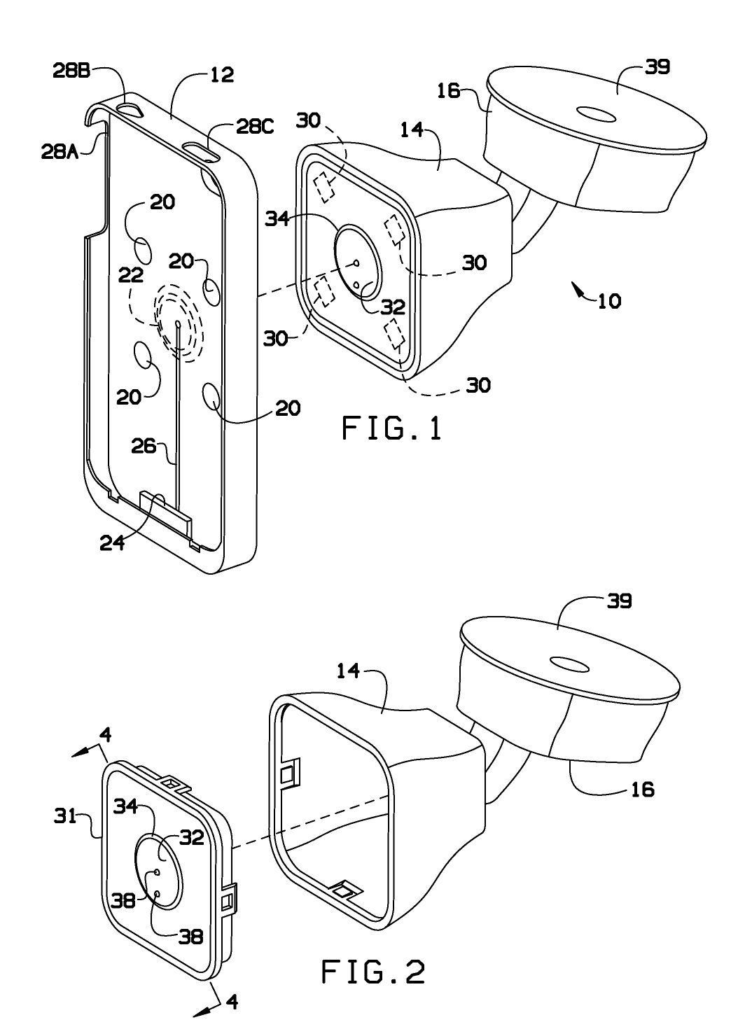

By way of example, and referring to FIG. 1 and FIG. 2, one embodiment of the present system comprises a mounting system 10 with a case 12, main housing 14, and base 16. The case 12 may include a plurality of metal plates 20 and a printed circuit board (PCB) 22, which may be circular in shape. The PCB 22 may be connected to a connector 24 by wiring 26. The case 12 may be customized to be compatible with different devices and models. For example, one embodiment of the case 12 may include a connector 24 and cutouts 28a, 28b, 28c, that are compatible with an IPHONE®. Other embodiments may be compatible with other devices or smartphone models. For example, the case 12 may be placed over the back and sides of a smartphone, or it may place the battery cover of the device.

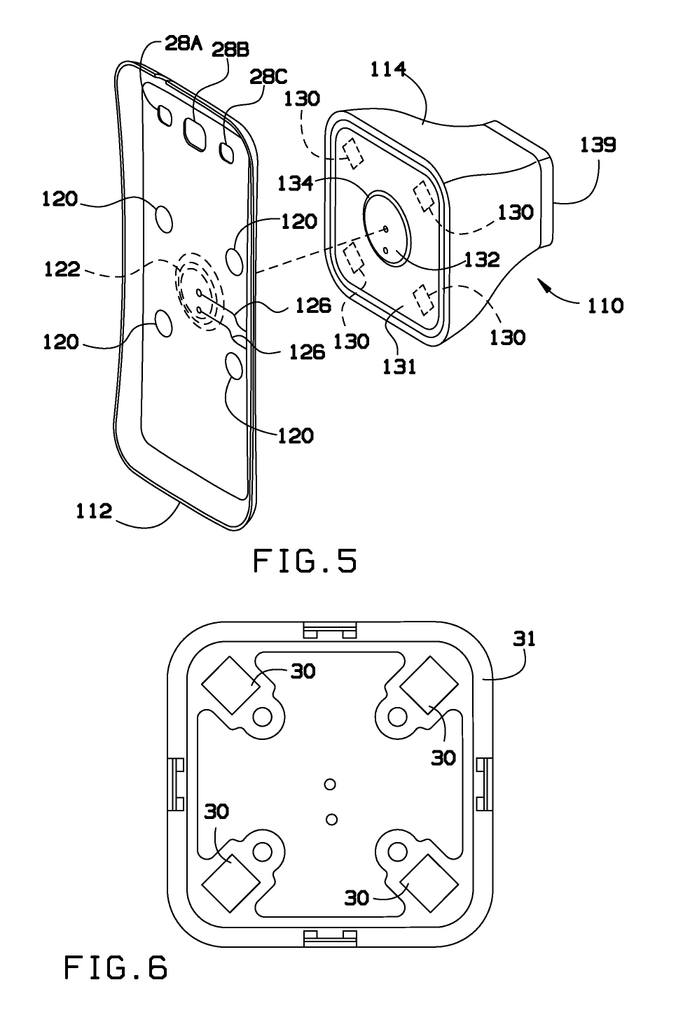

The housing 14 may include a plurality of neodymium magnets 30, which may be located behind a front plate 31. The plurality of magnets 30 may be arranged in diametrical positions. For example, the plurality of magnets 30 may be arranged in a square pattern, and they may be oriented diagonally with respect to the sides of the square. This pattern may be seen, for example, in FIG. 6. The plurality of magnets 30 may interact with the plurality of metal plates 20 in the case 12 to align the case 12 with the front plate 31. The housing may also include a recessed area surrounded by an embossed ring 34. As the plurality of magnets 30 draw the case 12 to the front plate 31, the recessed area 32 may interact with a protrusion around the PCB 22 in the case 12 to refine the alignment of the case 12 and the front plate 31. One or more pins 38 may be located in the recessed area 32. When the case 12 is in contact with the front plate 31, the plurality of pins 38 may contact the PCB 22 in the case 12. When contacting the PCB 22, the plurality of pins 38 may be able to provide an electric current to the case 12, which may charge the phone or device through the connecter 24. This configuration may allow a phone or other device to be mounted magnetically and start charging almost instantaneously, all simply by placing the phone on the mounting system 10. The housing may also include a suction cup 39 for connecting to a glass surface such as the windshield of a car or other vehicle. Alternative means of connection include clips for attaching to a vent, a weighted base for resting on a dashboard, and so on.

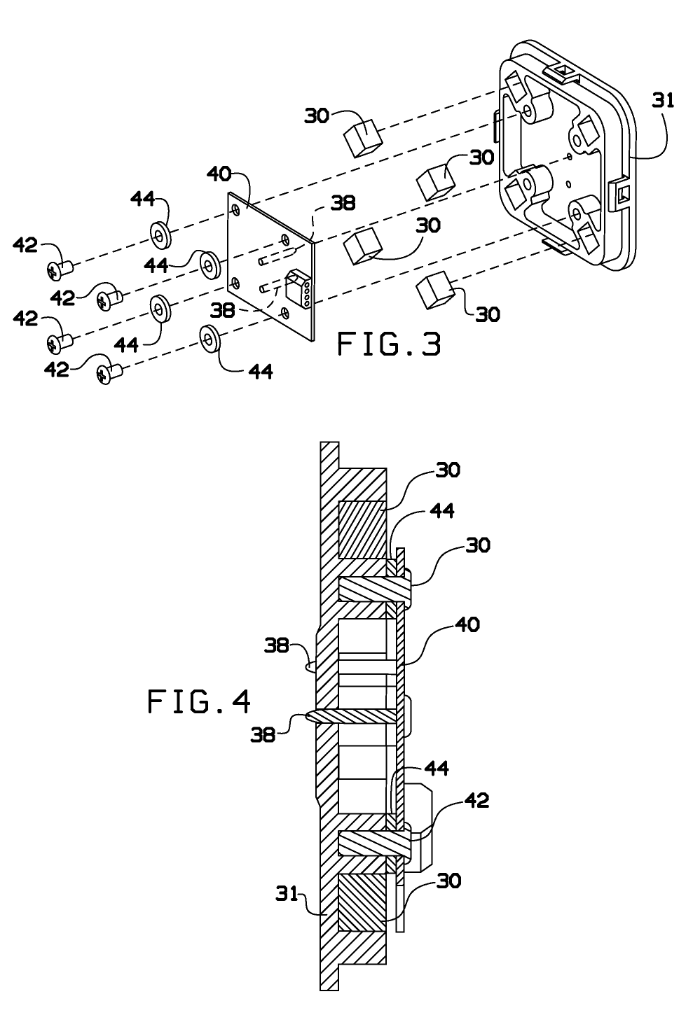

Referring to FIGS. 3, 4, and 6 the plurality of magnets 30 may fit into slots in the back of the front plate 31. The plurality of pins 38 may extend behind the plate 31 to a circuit board 40. The circuit board may be fastened to the front plate 31 by screws 42 and washers 44, or any other suitable means.

Optionally, a mounting system 10 may include a sensor or other mechanism to notify the phone that it is mounted. This notification may be used by software on the phone to start or interact with various software applications or components. The PCB 22 may be configured to receive an AC adapter, so that the phone may be charged using a traditional charger in addition to the mounting system 10.

Referring to FIG. 5, an alternative embodiment of the present disclosure may be configured to be mounted or positioned on a flat, stationary surface, such as, e.g., a desktop, shelf, table, nightstand, and so on. The alternative embodiment comprises a mounting system 110 with a case 112 and a housing 114. The case may include a plurality of metal plates 120, a PCB 122, and wiring 126 to a power connector (not shown). The case may include a power connector and cutouts 28a, 28b, 28c for a specific model of device or smartphone, such as a SAMSUNG GALAXY S3®.

The housing 114 may include one or more magnets 130, which may be covered by a front plate 131. The housing 116 may include a recessed area 132 surrounded by an embossed ring 134. The housing may include a mounting connector 139.

Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above.

What is claimed is:

1. A magnetic mounting system, configured to charge a personal electronic device with integrated conductive charging of the personal electronic device, the system comprising
a case, configured to connect to the personal electronic device; the case being attached to a printed circuit board, wiring and a plurality of metal plates;
a housing, arranged proximate the casing; wherein the housing further comprises a plurality of magnets and a plurality of pins;
wherein aligning the plurality of magnets with the plurality of pins detachably couples the case to the housing;
wherein aligning the plurality of pins and the printed circuit board provides electricity from the plurality of pins to the printed circuit board when the case is attached to the housing to charge the personal electronic device in the case.

2. The system of claim 1, further comprising a base mechanically coupled to the housing; and a suction cup mechanically coupled to the base wherein the suction cup is configured to detachably couple the base to a glass surface.

3. The system of claim 1, further comprising a front plate, mechanically coupled to the housing, wherein the front plate is directly attached to the plurality of magnets and the plurality of pins and a recessed area; wherein the recessed area is surrounded by an embossed ring.

4. The system of claim 3; further comprising a protrusion around the printed circuit board; wherein aligning the protrusion with the embossed ring aligns the case to the front plate.

5. The system of claim 4; further comprising a connector attached to the printed circuit board with wiring; wherein the connector is electrically coupled to the personal electronic device to charge the personal electronic device.
